(19) United States
(12) Patent Application Publication
(10) Pub. No.: US 2007/0284216 A1
(43) Pub. Date: Dec. 13, 2007

(54) Workpiece Machining Method and Workpiece Machining Device for a Transfer System With Machining Carried Out on a Number of Sides

(76) Inventors: Peter Meier, Frankfurt/M (DE); Detlef Gockel, Eschborn (DE)

Correspondence Address: RATNERPRESTIA, P O BOX 980, VALLEY FORGE, PA, 19482-0980, US

(21) Appl. No.: 11/547,108

(22) PCT Filed: Mar. 29, 2005
(86) PCT No.: PCT/EP05/51415

§ 371 Date: Jun. 18, 2007

(30) Foreign Application Priority Data
Mar. 30, 2004 (DE) 10 2004 016 071.6

(51) Int. Cl. B65G 37/00

(52) U.S. Cl. 198/346.2

(57) ABSTRACT

A workpiece machining method for a workpiece transfer system, wherein a workpiece and a workpiece carrier are introduced into a first station of the transfer system, and is subsequently machined in following stations wherein each station may comprise several manufacturing modules, and the workpiece is output in a last station.

This application is the U.S. national phase application of PCT International Application No. PCT/EP2005/051415, filed Mar. 29, 2005, which claims priority to German Patent Application No. DE 10 2004 016 071.6, filed Mar. 30, 2004.

### BACKGROUND OF THE INVENTION

1. Technical Field

The present invention relates to a workpiece machining method for a transfer system.

2. Description of the Related Art

Transfer systems, also referred to as transfer lines, are known in the art. The Invest Report 1/1999, page 11, of Messrs. Bosch discloses the transfer system MTS 2, for example. Transfer system MTS 2 has a modular design and comprises fully operable units with automatic stations and manual workplaces. Fully operable modules as regards mechanics, control, as well as the electric and pneumatic installation within complete function groups are provided, which are interconnected by means of three plug connectors for the installation. The transport of workpiece carriers is carried out using a conveyor belt, and each module of the transfer system is equipped with an own motor for driving the conveyor belt.

The prior art transfer system MTS 2 operates according to the following method. A manual station is used for an initial inspection and for introduction of workpieces into a main circulation system of the transfer system. A workpiece carrier is provided with codings enabling memorized information within the transfer system to be read out and the necessary process steps to be taken. Subsequently, the workpieces are fed to automatic stations. After a final assembly, each workpiece carrier returns into the original station, where an additional quality check takes place. Faultless workpieces are taken from the conveyor belt. Faulty workpieces undergo another passage, however, they will be heading only to the station required for remedy.

### SUMMARY OF THE INVENTION

An object of the invention involves providing a workpiece machining method, which along with a transfer system improves the efficiency and flexibility. Although prior-art operating methods allow a selective rework on faulty workpieces, the general production capacity is capable of improving.

This objective is achieved using a workpiece carrier transfer system, wherein a workpiece along with a workpiece carrier is introduced in a first station into the transfer system, is subsequently machined in following stations, which may comprise several manufacturing modules, and wherein the workpiece exits in a last station, and
a) a first side of the workpiece is machined in a first passage through the transfer system,
b) the workpiece, after its first passage through the stations, is automatically turned and put down again on the workpiece carrier, and
c) a second side of the workpiece is machined in a second passage through the transfer system.

According to the invention, the same workpiece passes several times through the same transfer line for machining on several sides. A two-axis x-y system with servo drives takes care of the positioning and transfer task.

In addition, a transfer system with a workpiece carrier is disclosed for implementing the method. Accordingly, a station is equipped with an automated handling device, especially with a robot, in order to take up workpieces from a workpiece carrier after a first passage and for preparing one or more additional passages, to turn the workpieces and place them in a defined, turned position on the workpiece carrier.

Further details of the invention can be seen with respect to the description and the drawings.

### BRIEF DESCRIPTION OF THE DRAWINGS

FIGS. 1a-1f show schematic diagrams of several process steps in a first passage of a workpiece WS1 for machining a first workpiece side E;

FIGS. 2a-2f show a turned workpiece WS1 together with a workpiece WS2 in their joint passage for machining the workpiece sides E and F;

FIGS. 3a-3e show a turned workpiece WS2 together with a workpiece WS3 in their joint passage for machining the workpiece sides E and F;

FIGS. 4 and 5 show perspective views of workpiece carriers with workpieces, and

FIG. 6 shows a transfer line.

### DETAILED DESCRIPTION OF THE PREFERRED EMBODIMENTS

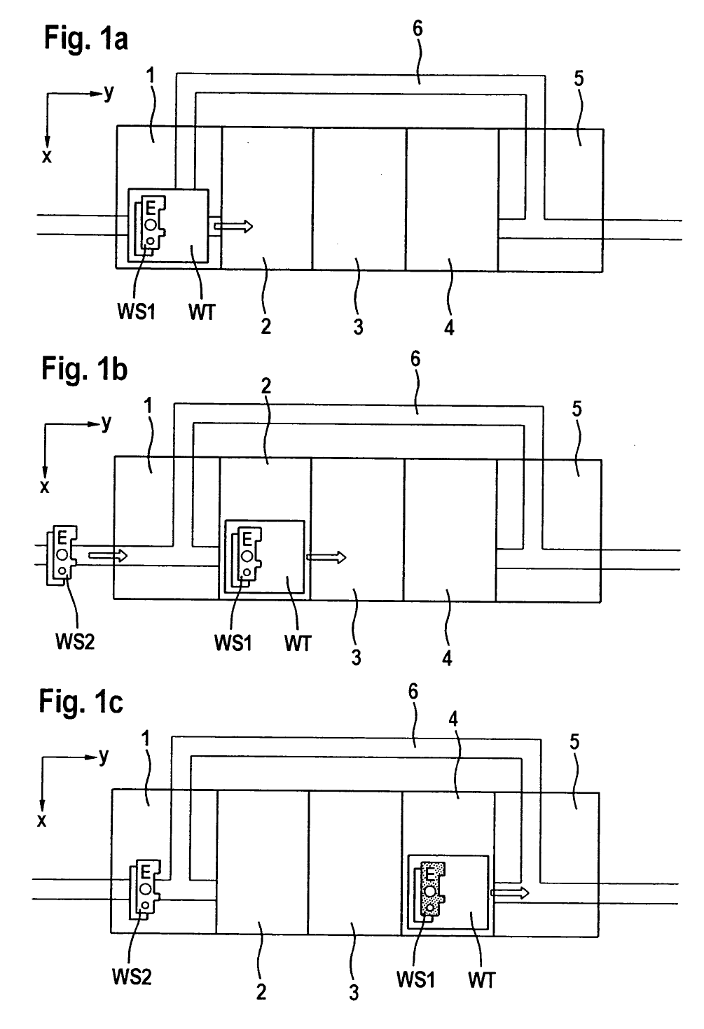

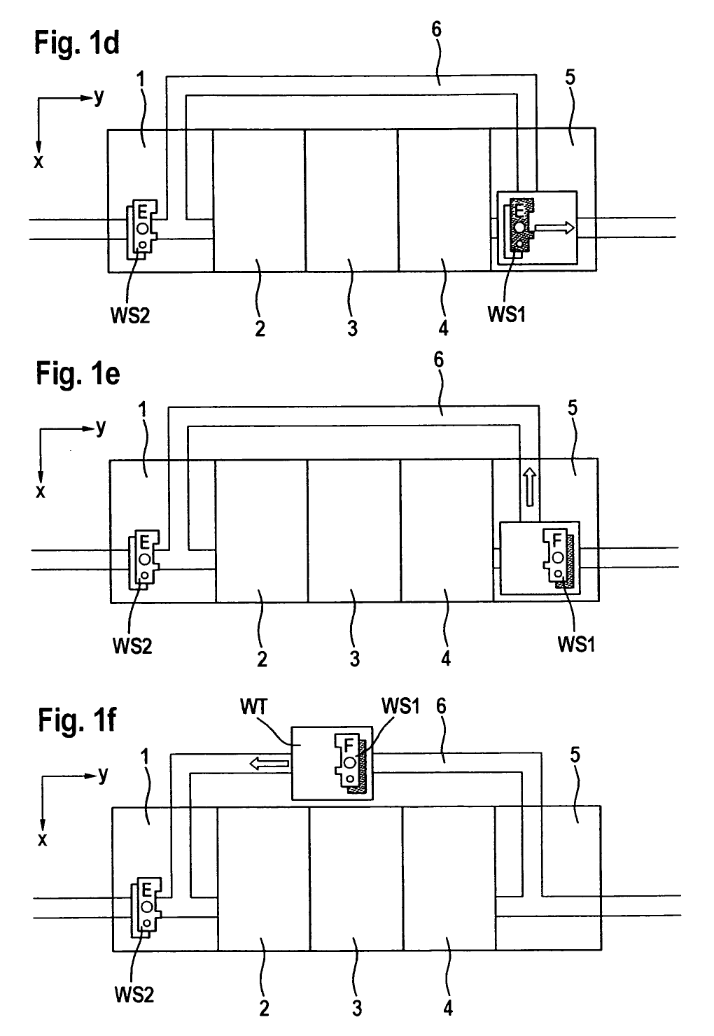

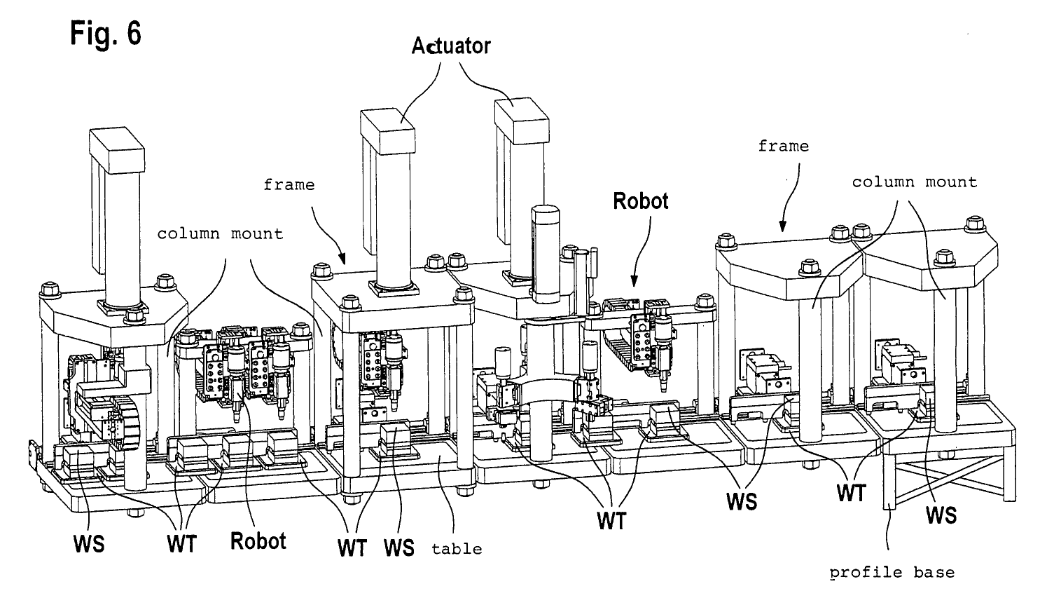

FIG. 6 shows an automatic manufacturing and assembling system of modular design based on a transfer system having manufacturing modules identical in their leading dimensions and with corresponding stations 1, 2, 3, 4, 5 (see FIGS. 1-3), which can be used especially for non-cutting but principally also for metal-cutting machining processes. A minimum of two and a maximum of as many manufacturing modules as desired may be provided. Each manufacturing module comprises one or more preferably stationary tool holding fixtures with a servo drive for a movement of the tools, and comprises a table for accommodating machining forces. The term ‘stationary’ refers to the x-y direction of coordinates and implies in the respect that the tool-holding fixture, for example for an exchange of tools, can be changed in place. However, displacements in the x- and y-direction are exclusively performed by the workpiece within the limits of machining operations. The tool is e.g. configured as a press and actively movable only in the z direction of coordinates for workpiece machining operations. To position the slide, a two-axis CNC system with servo drives and guides is used for the defined displacement of the slide in the direction of the illustrated x- and y-main axes within a machining space.

Of course, each manufacturing module is equipped with switches and/or sensors for gathering data related to machines, tools and workpieces, which connect to at least one local electronic controlling and regulating unit for the drives. The local controlling and regulating unit with an integrated machine protection imparts a self-supporting function to each manufacturing module. Means for the energy supply and information supply as well as for the communication among the individual manufacturing modules as well as for crosslinking to a superior electronic control station are provided. The servo drives for the slide perform both positioning movements for the workpiece carriers and feed motions for machining workpieces WS1, WS2, WS3. Further, the drives for the slide also serve for the transfer of the workpiece carrier WT from one manufacturing module to the next. The slide with its holding means (index gripping devices) indexes the (one or more) workpiece carrier WT, draws it into the manufacturing module, displaces it inside the manufacturing module to the required machining position (1 to n positions within the machining space of a manufacturing module are feasible), and transfers the workpiece carrier WT including workpiece WS from a current manufacturing module to a subsequent manufacturing module for further machining and processing operations.

This allows pressing, jointing and machining processes to be performed in the z-main axis direction (vertical direction) from the top to the bottom. For this purpose, each manufacturing module includes hydraulically, pneumatically or electrically/electromagnetically driven piston-and-cylinder assemblies. During the machining process, the workpieces WS are clamped in a defined fashion on the workpiece carrier WT, which is positioned in a defined manner within the machining space. The workpiece carrier WT abuts on the table so that the table accommodates machining forces.

In a basic design, a module consists of a table (table board with profile base), on which side elements of the workpiece carrier WT can slide, and where machining forces are introduced directly into the table. Stations 1, 2, 3, 4, 5, are disposed on the table as a manufacturing module with a column mount, with an actuator for machining tools (e.g. electric power-assisted press, hydraulic press, pneumatic-hydraulic press and/or jointer module with tools) operating preferably vertically in the z-main axis direction. Other, alternative equipments such as repositioning means or like elements are feasible. A frame is arranged above the table and allows providing the modules with doors, walls, and similar elements so that the machining space offers a clean, noise-abated and fail-safe atmosphere for passage and machining of the workpieces.

The modules have a uniform design and are standardized in terms of their leading dimensions. For the simple variation of the system, height and depth of the modules are identical, while their width can differ in general. For example, narrow modules can be provided, which perform less complex operations such as a transfer movement to the side. Therefore, the width (510 mm) of modules of this type principally can be dimensioned to be smaller than, preferably roughly half as large as, the width (1020 mm) of a standard module.

A manufacturing module comprises a large number of transducers, sensors and switches used to inquire positions, occupancies, etc., which may serve for the control, the machine protection as well as the operator protection. These safety devices are provided in a self-supporting fashion for each module, but they communicate in a module-overlapping fashion. This means that each manufacturing module is always informed at least about the status of adjacent manufacturing module. If necessary, each manufacturing module still comprises a picture taking means. The mentioned electric and electronic sensors and components connect to the local electronic controlling unit that is integrated into the manufacturing module. This type of construction renders each manufacturing module fully self-supporting and exchangeable, what relates especially to the handling of the workpiece carrier. There is no need for a belt band that is susceptible to wear.

Due to the principally equal and optionally even identical design of the manufacturing modules, it is even possible to arrange them flexibly at any location desired within the transfer system. The first-time programming of working steps can be loaded by a superior control station.

In general, the transfer system is appropriate for use in all metal-cutting and non-cutting machining processes, which are relevant in terms of series production. These are, for example: calking, punching, shaping, riveting, cementing, welding, placing, chipping, measuring, testing, and many more. The transfer system, however, is especially well suited for so-called ball-type engagements, where a hard and oversized roller bearing ball made of roller bearing steel is pressed into an undersized bore of an accommodating member made of a comparatively soft material, in order to obtain a low-cost pressure-fluid-tight bore closure in this way. Another potential application relates to so-called clinched engagements for electromagnetically operable valves, or pump bushings, covers, or similar elements.

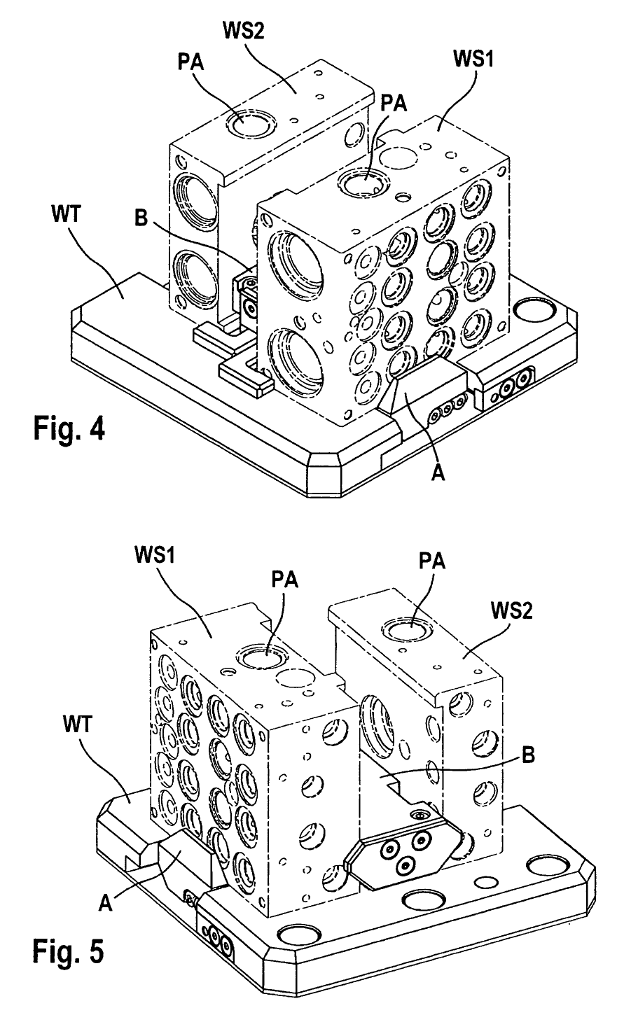

A multi-stage machining process can be taken from FIGS. 1a to 1f. According to FIG. 1a, a workpiece WS1 with a side E to be machined facing upwards is seated in an accommodation A (see FIGS. 4 and 5) of a workpiece carrier WT, which is disposed in a first station 1. According to the drawings 1b and 1c, the workpiece WS1 is successively machined in conformity with the desired degree, and completed in stations 2 and optionally 3. The surface of the workpiece WS1 in FIG. 1c, shaded in grey, illustrates the completed manufacturing or assembling process on this workpiece side. According to FIGS. 1d and 1e, the workpiece carrier WT together with the partly finished workpiece WS1 is transferred to the exhaust station 5. At this location, the workpiece WS1 is turned in an automated manner by means of a handling device such as a robot in particular, so that an unmachined surface (bottom side F) faces upwards. After the turning operation, the workpiece WS1 is put down on the workpiece carrier WT again. The accommodation B (see FIGS. 4 and 5) is used to this end so that the opposite accommodation A stays initially empty. Consequently, the two accommodations A, B can alternately clamp different workpieces at different sides. The necessary adaptation of clamping devices is carried out automatically.

A return process takes place through return path 6 according to FIGS. 1e and 1f. The return process is terminated when the workpiece WS1 together with the workpiece carrier WT reaches the charging station 1 again.

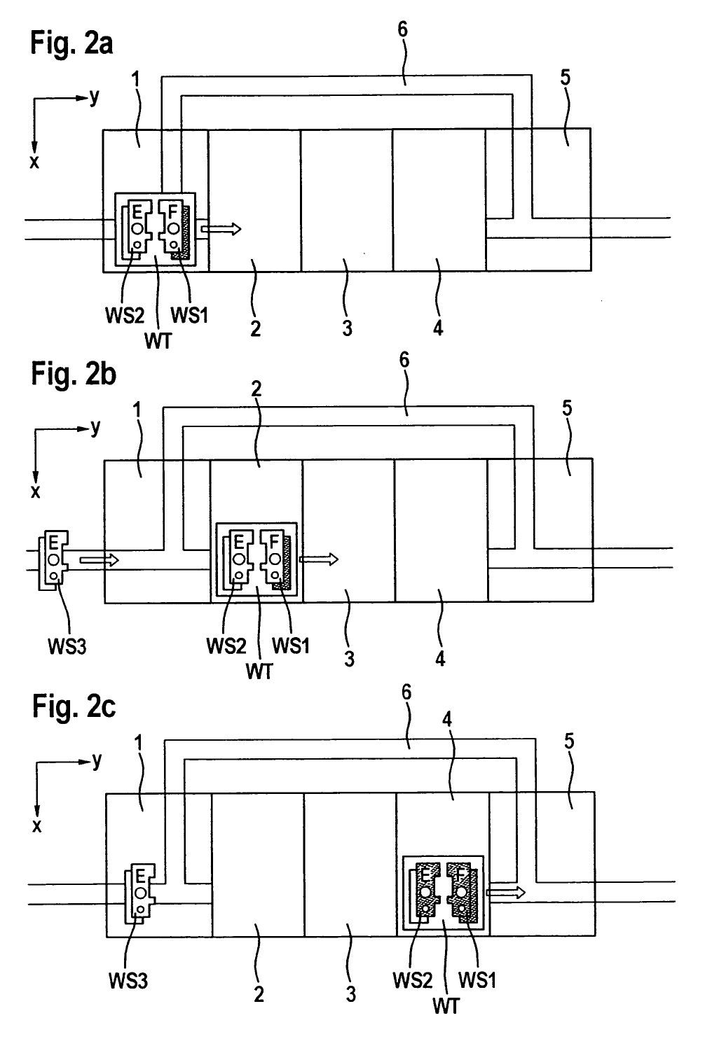

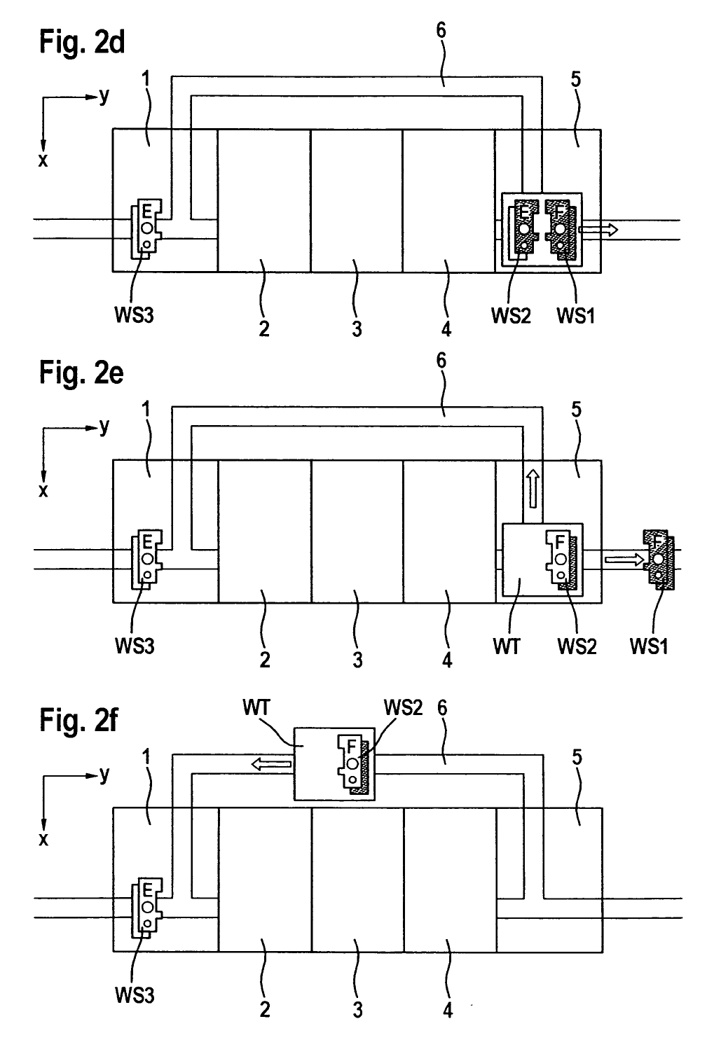

As can be seen, an unmachined workpiece WS2 with an unmachined top side E has been made available already in station 1. According to FIG. 2a, the workpiece WS2 is put on the workpiece carrier WT and clamped by means of accommodation A, which is provided for machining top sides. Following are the machining steps for the two machining sides E and F according to FIG. 2b. According to FIG. 2c, a completely finished workpiece WS1 and a workpiece WS2 finished on one side prevail. According to FIGS. 2d and 2e, workpiece WS1 may now be output, while workpiece WS2 according to FIG. 1e is turned and transferred to the accommodation B until it can start its return transfer to the charging station 1 according to FIG. 1f.

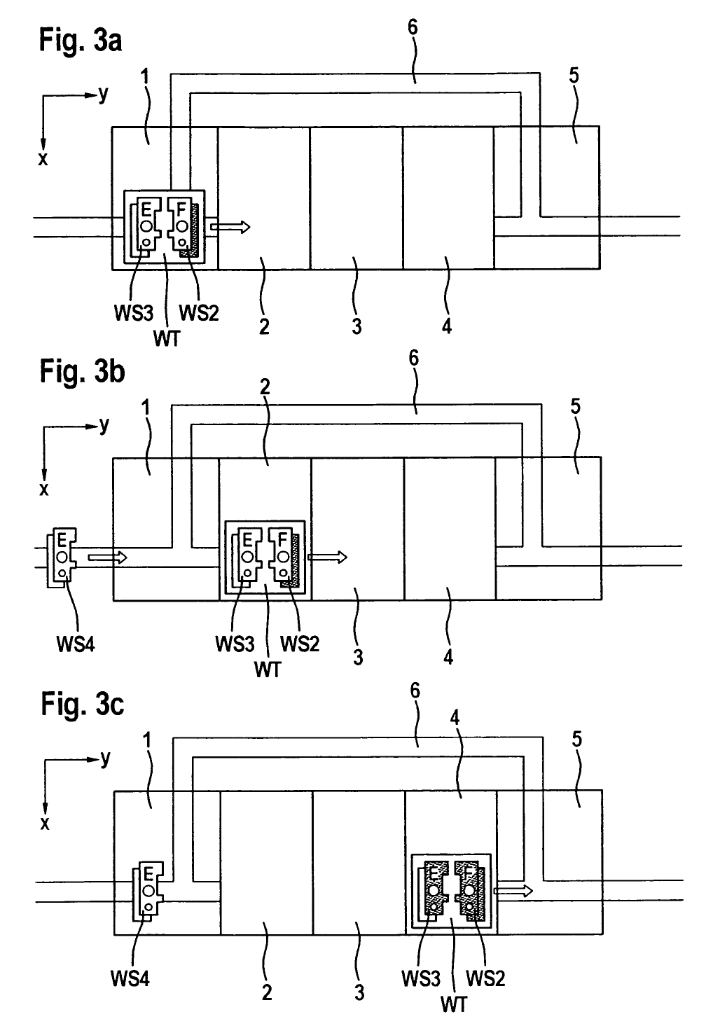

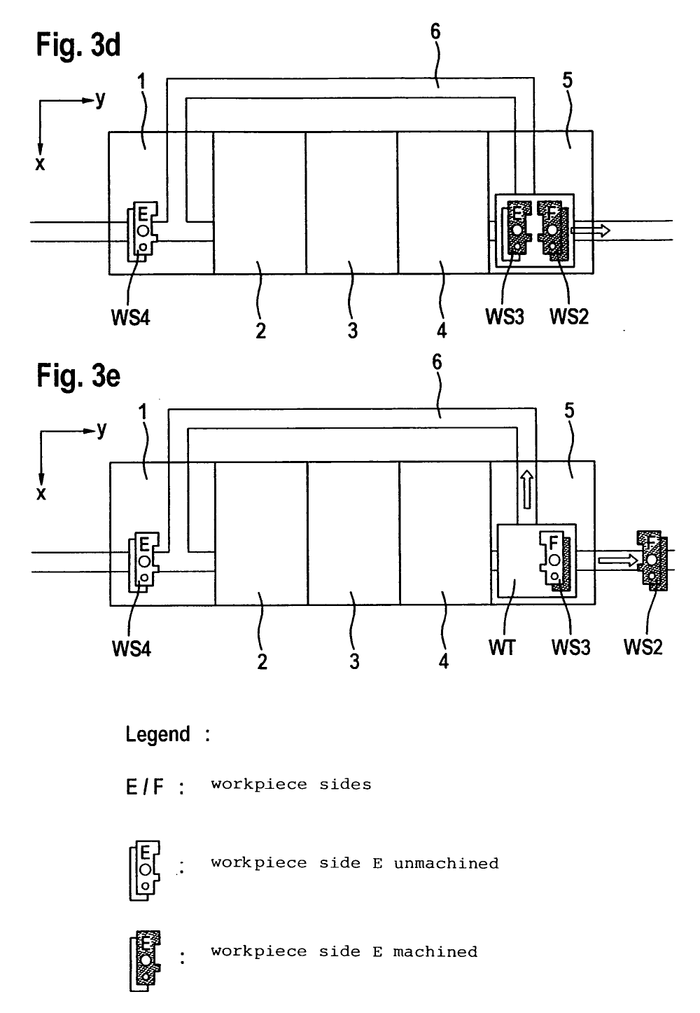

According to FIGS. 3a to 3e, the process is repeated as described hereinabove by way of FIGS. 2a to 2f with regard to the unmachined, available workpiece WS3 and with regard to the workpiece WS2 machined partly on side E. It is self-explanatory that principally as many cycles as desired for as many workpiece sides as desired with as many workpieces WSN as desired may follow, without departing from the spirit of the invention. As regards cubical workpieces, it is e.g. possible to machine more than only two sides in the process if the design allows so. It is essential only that processes with partly filled workpiece carriers WT will principally occur only twice, i.e. when the work starts and when the work ends. Besides, there is double occupancy of each workpiece carrier, which is utilized to impart double functionality to each station 1 to 5. Enhanced flexibility is the result.

All machining processes and the workpiece transfer, basically, are carried out fully automatically under NC and CNC control. Further, machining and processing operations take place under clean-room conditions in order to prevent lack in cleanliness and, consequently, frequent defects. An air filter system for the production hall is advisable for this purpose.

FIGS. 4 and 5 illustrate in detail a workpiece carrier WT, on which two different workpieces WS1 (MK 25E), WS2 (MK 70) (having concurrent bores though, herein pump-accommodating bores PA) are clamped into accommodations A, B. The workpieces are clamped e.g. using spring means, which are spread apart by a gripping device before the workpiece WS is put down.

It is, however, principally also possible to execute the clamping operation electrically/pneumatically or hydraulically. It is self-explanatory that the accommodations A, B of the workpiece carrier WT comprises suitably adapted clamping devices for the workpieces MK 25E, MK 70. As the workpieces in one example of application concern valve blocks, which are principally made of aluminum or plastic material, mechanical clamping means are used in first place. However, electromagnetic clamping means are ruled out for these applications to a large degree. They are applicable when the materials are ferromagnetic materials, which shall be machined or processed.

1-12. (canceled)

13. A workpiece machining method for a workpiece transfer system comprising:
positioning a workpiece on a workpiece carrier in a first orientation at a first work station;
passing the workpiece through one or more following stations in a first passage;
machining a first side of the workpiece as the workpiece is passed through the one or more following stations in the first passage;
automatically repositioning the workpiece on the workpiece carrier in a second orientation;
passing the workpiece through the one or more following stations in a subsequent passage; and
machining a second side of the workpiece as the workpiece is passed through the one or more following stations the subsequent time.

14. The workpiece machining method according to claim 13, wherein each following station comprises one or more manufacturing modules.

15. The workpiece machining method according to claim 13, further comprising:
outputting the workpiece at a last station after at least one subsequent passage.

16. The workpiece machining method according to claim 13, wherein the workpiece, after the first passage is returned to the first station via a return path.

17. The workpiece machining method according to claim 13, wherein the workpiece undergoes n passages, with n representing a number of the sides of the workpiece, and the workpiece is repositioned n−1 times.

18. The workpiece machining method according to claim 13, wherein the workpiece carrier includes at least two accommodations for two workpieces, and the accommodations are charged accordingly.

19. The workpiece machining method according to claim 18, wherein a first workpiece for a first passage and a second workpiece for a subsequent passage are provided in respectively different accommodations on the workpiece carrier.

20. The workpiece machining method according to claim 18, wherein the workpiece carrier includes a defined accommodation for machining a top side of a workpiece and a defined accommodation for machining a bottom side of a workpiece.

21. The workpiece machining method according to claim 18, wherein after a first passage of a first workpiece, two workpieces are positioned on the workpiece carrier.

22. The workpiece machining method according to claim 13, wherein unmachined workpieces are made available in a stand-by area of the transfer system, and a respective workpiece made available is positioned on the workpiece carrier and introduced into the transfer system after the output of a finished workpiece.

23. A transfer system for implementing the method according to claim 13, wherein a station is equipped with an automated handling device configured to reposition the workpiece to the second orientation after the first passage.

24. The transfer system according to claim 23, wherein the automated handling device is a robot.

25. A transfer system for implementing the method according to claim 13, wherein the workpiece carrier includes at least two accommodations for two different workpieces.

26. A transfer system according to claim 25, wherein the accommodations are designed to automatically adjust themselves so that each of the accommodations is adapted to accommodate a respective workpiece.

27. A transfer system for implementing the method according to claim 13, wherein the workpiece carrier includes clamping means for the workpiece, and the clamping means includes at least one spring.
